(19) United States
(12) Patent Application Publication
(10) Pub. No.: US 2026/0228603 A1
(43) Pub. Date: Aug. 6, 2026

(54) AUTOMATED PERFORMANCE MONITORING AND RETRAINING OF MACHINE LEARNING MODELS

(71) Applicant: Akamai Technologies, Inc., Cambridge, MA (US)

(72) Inventors: Akul Dewan, Roswell, GA (US); Leonid Mirkis, Newton, MA (US)

(21) Appl. No.: 19/042,571

(22) Filed: Jan. 31, 2025

(51) Int. Cl. G06N 20/00

(52) U.S. Cl. CPC G06N 20/00

(57) ABSTRACT

Disclosed are systems and methods that automatically monitor the performance of machine learning models operating in a production system and that improve them through automated retraining to meet configured performance standards.

### BACKGROUND

### Technical Field

This application generally relates to the use of machine learning and distributed computing systems.

### Brief Description of the Related Art

Trained machine learning (ML) models are used to evaluate an input (such as network traffic) for a desired purpose, such as to classify the input. Models are typically trained in an offline, non-production environment, e.g., by curating data for training and feeding that data into a carefully designed ML model in a lab setting. Once trained, models are deployed to live production systems, where the model is used for inferencing, meaning that new, live data is applied to the ML model. The ML model produces an output, such as a classification with a confidence score, or other output. The output is commonly referred to as the ML model’s ‘prediction’. Over time, however, ML model’s performance may degrade, which is a problem sometimes referred to as ‘drift’.

Drift is a problem, for example, in the realm of network security. Drift can occur for many reasons, but generally speaking the underlying issue is that the trained ML model might not be able to correctly classify traffic as benign or an attack because of new/novel types of attacks or benign traffic patterns evolving over time. Although less of a factor usually, the training data can become stale because the characteristics of benign traffic may change over time as new services, features, interfaces, devices, and content are deployed on a site. As a remedy, the ML model can be retrained on updated or more accurate data. Then the production ML model can be upgraded to the newly trained ML model. The need for retraining may not be immediately recognized, however, and even when it is, retraining is a costly, time consuming, manual process. Oftentimes, retraining is performed only occasionally.

It would be beneficial to have a computing system automatically, accurately, and reliably recognize when a trained ML model is performing outside of desired benchmarks. It would be beneficial to be able to identify appropriate data to use in updating the training and to retrain the ML model with such data.

The teachings hereof address these needs and others. The teachings hereof provide an integrated, closed loop system that continually monitors the performance of a trained ML model operating in production, detects subpar performance due to drift, and automatically retrains and updates the machine learning model in production. The teachings hereof apply to any type of ML model that can be retrained, including without limitation regression modeling, decision trees, neural networks and supervised clustering.

The teachings presented herein improve the functioning of a computer system itself, improving the caching function in an individual server as well as that of a larger distributed system having many such servers. Those skilled in the art will understand these and other improvements from the teachings hereof.

### BRIEF SUMMARY

This section describes some pertinent aspects of this invention. Those aspects are illustrative, not exhaustive, and they are not a definition of the invention.

Disclosed are systems and methods that automatically monitor the performance of machine learning models operating in a production system and that improve them through automated retraining to meet configured performance standards.

The claims are incorporated by reference into this section, in their entirety.

### BRIEF DESCRIPTION OF THE DRAWINGS

The invention will be more fully understood from the following detailed description taken in conjunction with the accompanying drawings, in which:

FIG. 1A is a diagram illustrating a system that automatically monitors the performance of machine learning models in production systems and improves them through automated retraining to meet configured performance standards, in one embodiment of the teachings hereof;

FIG. 1B is a diagram illustrating a particular use case and discrete example of the system shown in FIG. 1A, in one embodiment of the teachings hereof; and,

FIG. 2 is a block diagram illustrating hardware in a computer system that may be used to implement the teachings hereof.

Numerical labels are provided in some FIGURES solely to assist in identifying elements being described in the text; no significance should be attributed to the numbering unless explicitly stated otherwise.

### DETAILED DESCRIPTION

The following description sets forth embodiments of the invention to provide an overall understanding of the principles of the structure, function, manufacture, and use of the methods and apparatus disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different hosts in a variety of ways.

Any reference to advantages or benefits refer to potential advantages and benefits that may be obtained through practice of the teachings hereof. It is not necessary to obtain such advantages and benefits in order to practice the teachings hereof.

All references to HTTP should be interpreted to include an embodiment using encryption (HTTP/S), such as when TLS secured connections are established. While context may indicate the hardware or the software exclusively, should such distinction be appropriate, the teachings hereof can be implemented in any combination of hardware and software. Hardware may be actual or virtualized.

### Overview

In preferred embodiments, a trained ML model is used in a production system to analyze inputs, such as network traffic. The outputs (predictions) of the trained ML model are used by the production system for various purposes (e.g., to determine how to handle the network traffic). They are also copied to an offline, non-production system that evaluates the trained ML model’s performance against a set of rules that is authoritative for at least some situations (e.g., for at least some class of inputs) though perhaps not all. The performance of the trained ML model is assessed and if it falls below configured performance indicators, a retraining process is triggered. The system can use the same underlying (untrained) ML model, but that model is re-trained with updated training data that was also captured by the non-production system and labeled as part of the performance assessment. The newly trained, updated ML model can be automatically pushed back to the production system (e.g., as a new version). Generally that occurs after automated benchmark validation, which checks that the new automatically trained model is not producing unreasonable or incoherent results for some reason (e.g., a kind of sanity check). The system can version training data (captured from the production system) and trained ML models over time. In this way, when performance drops the corresponding set of data can be used for retraining. Other factors, such as user configuration changes (e.g., a user override) to the production system’s use of the trained ML model’s output can also be signals incorporated into the performance assessment and retraining workflow.

With the foregoing by way of non-limiting overview, further details are now provided.

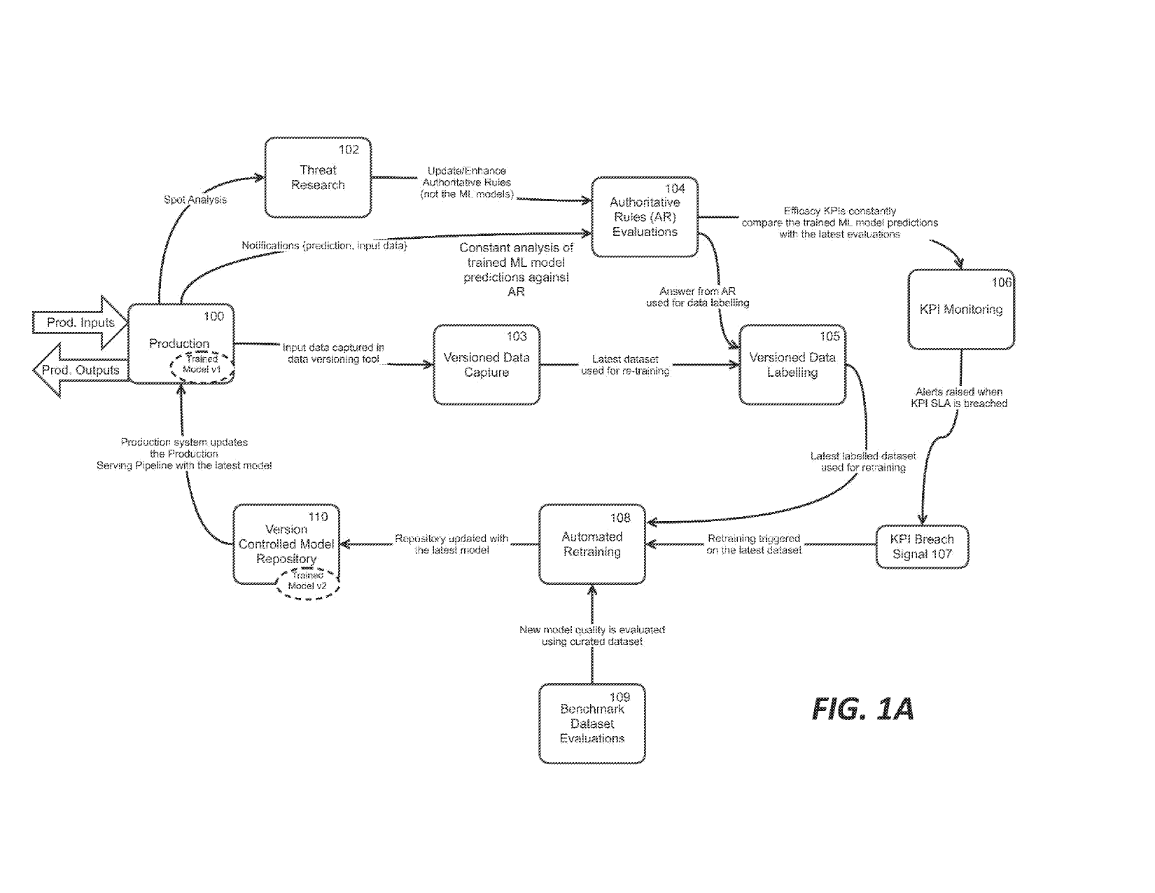

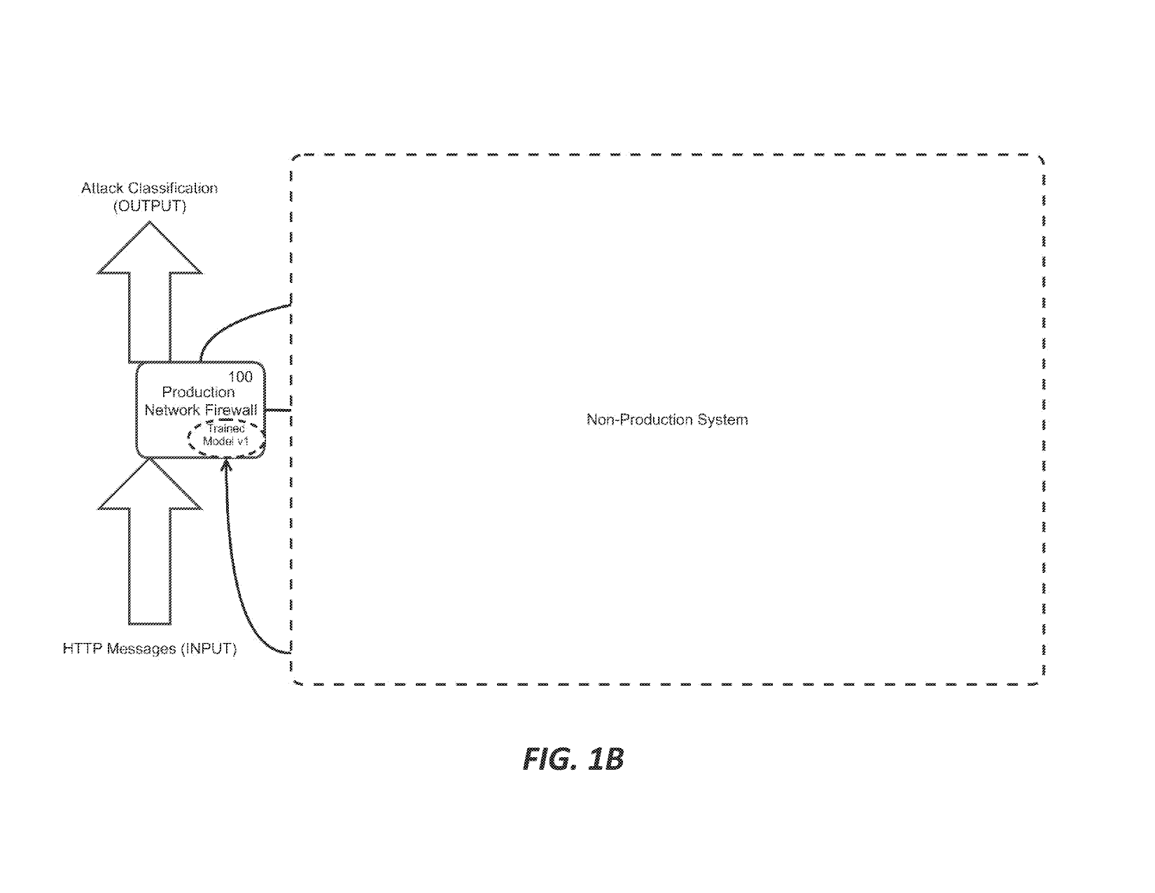

FIG. 1A is a flow diagram illustrating a process for automated evaluation and retraining of machine learning models, at least in one embodiment.

Box 100 represents a production system that is utilizing a trained machine learning (ML) model, which is shown as “Trained Model v1”. The production system 100 can be any type of system that leverages a trained ML model to determine how to handle an input. Assume that the production system 100 is receiving inputs and producing outputs (shown as the outlined arrows on the left hand side of 100 with ‘prod. input’ and prod.output’ where ‘prod.’ refers to production.

The production system 100 interacts in a variety of ways with a set of components 102 through 110, which are referred to as the non-production system.

By way of a discrete example, consider FIG. 1B, which indicates that the production system 100 is a network device or platform that is analyzing incoming network traffic, such as HTTP messages. (An example of a network based web application firewall is available in US Patent No. 8,458,769, the teachings of which are hereby incorporated by reference in their entirety.) The incoming HTTP messages are examined for attacks or other malicious activity. The system 100 applies the messages to the trained ML model to make that assessment, and acts accordingly, blocking or alerting on HTTP messages deemed to be malicious. (Note the prediction made by the trained ML model in this case is probabilistic, as is typical of inferencing with many machine learning models.)

Returning to FIG. 1A, the production system 100 is monitored by threat researchers and other security personnel, e.g., via dashboards and alerting, see box 102. In addition, the production system 100 sends notifications to the AR Evaluations component 104. Such notifications can contain information about the prediction made by the trained ML model in the production system 100, including not only the prediction but the input data (or portion of input) that was being evaluated.

The AR Evaluations component 104 checks the accuracy of the trained ML model as it operates in the production system 100. It applies an authoritative ruleset to the same input data (taken from the notifications) and produces an answer. This answer is compared to the prediction that the trained ML model in the production system 100 had made. This comparison result is sent to the Key Performance Indicator (KPI) Component 106.

The authoritative ruleset can be a set of rules or heuristics developed over time by the threat research 102 teams, and/or an external source of truth (bad actor identifiers, client IP reputation, trusted actors, etc.). It is not necessary for the authoritative ruleset to address all situations; rather it should be highly accurate and highly recurring when it does produce an answer. For example, continuing with the example from above: assume the input is an HTTP message(s) being evaluated for attacks. The authoritative ruleset may not be able to detect all kinds of attacks, but if it determines that a message contains a particular type of attack, that determination is considered to be very accurate (above and beyond the prediction made by the trained ML model in the production system 100).

Hence, the authoritative ruleset is a set of potentially many rules, each of which are treated as “truths” in the context of what is being analyzed. One rule may be designed to capture false negatives in making a particular traffic classification (e.g., detecting an attack of a particular type, to continue the examples from above). Another rule may be designed to capture false positives in making that particular traffic classification. Put another way, the authoritative ruleset provides a number of “truths” for given tuples of inputs. The job of the trained ML model in production 100 is to assess all input tuples, including the tuples for which there is a “truth”, and those where there is no known truth (interpolation or extrapolation). But the trained ML model should not be deviating from the truths, at least not to a significant degree (which is assessed in box 106).

Typically, the authoritative ruleset is updated over time as new attacks or new ways of detecting attacks are developed, if those developments might affect the KPIs and trained model quality.

Returning to FIG. 1A, the production system 100 also is sending the input data (the “prod. inputs” in FIG. 1A) to versioned data capture component 103, which is then labeled at 105 with the answers from the Authoritative Rules produced by 104. This means that the input data is captured to support future retraining. A variety of versioning schemes can be used for the input data, but preferably the version indicates an epoch or timestamp, a production system 100 identifier, and which version of ML model (v1) was being used when the data was being captured. The input data may also be tagged in a way that enables the answer from 104 to be matched or associated to the input data for labeling in 105.

The KPI monitoring component 106 programmatically assesses the performance of the trained ML model in production 100 against a set of configured key performance indicators. The KPI monitoring component 106 can track the differences between the predictions given by the trained ML model in production 100 (that is, the “prod. outputs” in FIG.1A) and the answers given by the authoritative ruleset 104 and . Such tracking may occur over a period of time and over a certain amount of information coming from 104, so as to smooth data and have confidence in the performance trend. A user can configure the KPI monitoring component 106 with one or more key performance indicators (KPIs) that are tied to a service level agreement or expectation for the production system 100.

For example, continuing the network firewall example, a simple KPI might be defined as the trained ML model’s prediction deviating from the authoritative ruleset’s answer no more than X percent of instances for a given attack type over a configured time period. Note that the KPI could also be based on confidence scoring, e.g., even when the trained ML model’s prediction is deemed to be correct based on the answer from 104, the trained ML’s model confidence score about such correct prediction should be higher than a certain score Y. This may help catch drift early.

In a more complex arrangement, a variety of KPIs are used. For example, KPIs may include the following parameters drawn from a set of data:

Coverage -- This starts with the raw number of answers given by the authoritative ruleset and the raw number of predictions given by the trained ML model. These should match as they represent the total decisions made by each one. The coverage data further includes the recommendations of each path. This means the answers provided by the authoritative ruleset (e.g., attack or not an attack) and the predictions of the trained ML model (e.g., attack or not an attack). The coverage comparison looks at how often the ML model’s prediction deviates from the authoritative ruleset. Note that the comparison may be on a granular basis. For example, for each firewall rule, how often did the ML model (i) get it right, (ii) falsely designate an attack (false positive), and (iii) miss an attack (false negative).

ML Precision and Sensitivity -- These parameters are outputs/signals produced by the trained ML model as it operates (inferencing). These parameters are known in the art. They are used to evaluate performance.

Matthews Correlation Coefficient (MCC) -- This parameter is also produced as part of the operation of the trained ML model, as known in the art. They are used to evaluate correlation of the results produced by the ML model and the authoritative ruleset.

Population Stability Index -- As known in the art, this parameter is used to quantify data drift over time. The term data drift here refers to changes in the input to the system. For example, a firewall system may see changes in the volume and types of attacks which affects input traffic. Furthermore, a website owner may change the structure, content, or other aspect of their website or web application, which can produce drift in the characteristics of normal and malicious traffic to the site. In effect, the population stability index captures the differences between the training data and the current input being seen by the ML model.

Long term KPI trends- -the long term (e.g., weekly) trends of the above measurements.

The KPI Monitoring Component tracks the above KPIs and evaluates them both individually and in combination with one another to determine when to trigger a retraining. When that occurs , the KPI Monitoring Component 106 sends a signal (at 107, KPI Breach signal) to the automated retraining component 108. As mentioned, the trigger for retraining is preferably based on a combination of the KPIs. In some cases, poor performance for a single KPI might trigger retraining, e.g., if the deviation from expected performance is extreme and/or the KPI is sufficiently important. The teachings hereof are agnostic to exact trigger levels and the exact function of combined KPI levels that trigger a retraining. The levels and trigger points would be tuned in an ongoing process, dependent on the specific design goals, desired service level agreements, and use cases, as those skilled in the art will understand.

The automated retraining component 108 component fetches the appropriate training data from 105, which now is updated as it includes the input data that caused the trained ML model in production 100 to make the wrong prediction, which data is now labeled with the answers from 104. Component 108 pulls the appropriate untrained (or partially trained) ML model from a repository and retrains it (or supplements) on the latest labeled dataset.

Once training is complete, the new version of the ML model (v2 in FIG. 1) is checked against a curated dataset which is referred to as the benchmark dataset 109 in FIG. 1A. This process is known in the art.

Upon successful retraining, the new version of the ML model is complete and it is shown as “Trained Model v2”. It is transmitted to the model repository 110 which has a control channel to the production system 100. The updated ML model is deployed to the production system 100, e.g., via push or periodical pull or other suitable mechanism.

### Tenant Tuning Actions

While not shown in FIG. 1A, in some embodiments there is another source of feedback about the performance of the trained ML model in production 100. This feedback is relevant when the production system 100 is a multi-tenant system (e.g., CDN, security platform) where users are able to configure the system with how to handle their particular traffic (e.g., traffic to their domain). Technologies for such configuration are known in the art, see, e.g. US Patent Nos. 7,240,100; 9667747 ; 9736271 ; 9942363 ; 10237374 ; 10257318 ; 10530900 ; 9654579 ; 10237363, the teachings of all of which are hereby incorporated by reference.

In these multi-tenant systems, a relevant configuration change by the tenant is considered as feedback. A relevant configuration change would include one that overrides or alters a prediction made by the ML model in the production system 100. For example, if a tenant configures a rule that specifically allows certain traffic to pass the network firewall, whereas the trained ML model in production 100 was indicating that such traffic was malicious (and the firewall thus denying or flagging such traffic) then this information is treated as proof that that the input traffic was a false positive. That information is fed into and considered in component 104. In other words, it is considered the “answer” for the corresponding input data.

### Computer Based Implementation

The teachings hereof may be implemented using conventional computer systems, but modified by the teachings hereof, with the components and/or functional characteristics described above realized in special-purpose hardware, general-purpose hardware configured by software stored therein for special purposes, or a combination thereof, as modified by the teachings hereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus – such as a microprocessor in a computer, digital data processing device, or other computing apparatus – as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

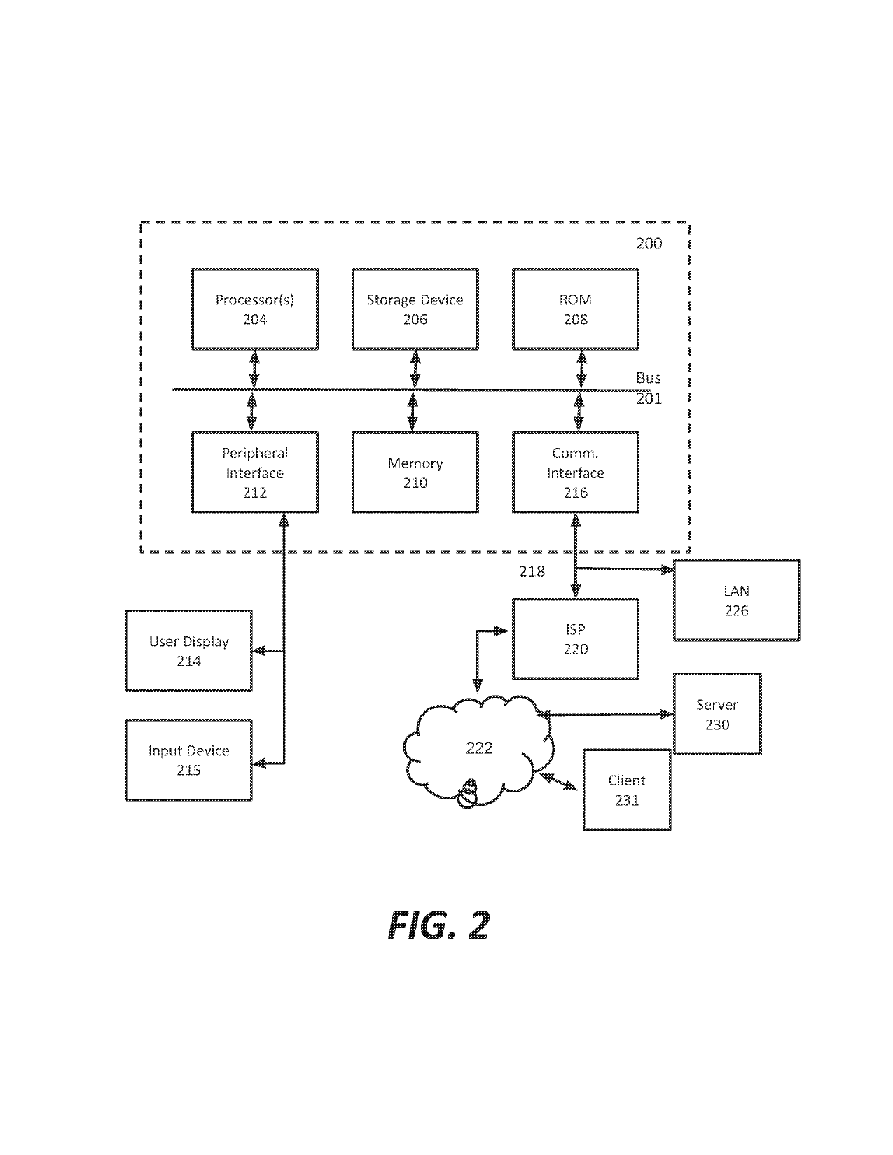

FIG. 2 is a block diagram that illustrates hardware in a computer system 200 upon which such software may run in order to implement embodiments of the invention. The computer system 200 may be embodied in a client device, server, personal computer, workstation, tablet computer, mobile or wireless device such as a smartphone, network device, router, hub, gateway, or other device. Representative machines on which the subject matter herein is provided may be a computer running a Linux or Linux-variant operating system and one or more applications to carry out the described functionality.

Computer system 200 includes a microprocessor 204 coupled to bus 201. In some systems, multiple processor and/or processor cores may be employed. Computer system 200 further includes a main memory 210, such as a random access memory (RAM) or other storage device, coupled to the bus 201 for storing information and instructions to be executed by processor 204. A read only memory (ROM) 208 is coupled to the bus 201 for storing information and instructions for processor 204. A non-volatile storage device 206, such as a magnetic disk, solid state memory (e.g., flash memory), or optical disk, is provided and coupled to bus 201 for storing information and instructions. Other application-specific integrated circuits (ASICs), field programmable gate arrays (FPGAs) or circuitry may be included in the computer system 200 to perform functions described herein.

A peripheral interface 212 may be provided to communicatively couple computer system 200 to a user display 214 that displays the output of software executing on the computer system, and an input device 215 (e.g., a keyboard, mouse, trackpad, touchscreen) that communicates user input and instructions to the computer system 200. However, in many embodiments, a computer system 200 may not have a user interface beyond a network port, e.g., in the case of a server in a rack. The peripheral interface 212 may include interface circuitry, control and/or level-shifting logic for local buses such as RS-485, Universal Serial Bus (USB), IEEE 1394, or other communication links.

Computer system 200 is coupled to a communication interface 216 that provides a link (e.g., at a physical layer, data link layer,) between the system bus 201 and an external communication link. The communication interface 216 provides a network link 218. The communication interface 216 may represent an Ethernet or other network interface card (NIC), a wireless interface, modem, an optical interface, or other kind of input/output interface.

Network link 218 provides data communication through one or more networks to other devices. Such devices include other computer systems that are part of a local area network (LAN) 226. Furthermore, the network link 218 provides a link, via an internet service provider (ISP) 220, to the Internet 222. In turn, the Internet 222 may provide a link to other computing systems such as a remote server 230 and/or a remote client 231. Network link 218 and such networks may transmit data using packet-switched, circuit-switched, or other data-transmission approaches.

In operation, the computer system 200 may implement the functionality described herein as a result of the processor executing code. Such code may be read from or stored on a non-transitory computer-readable medium, such as memory 210, ROM 208, or storage device 206. Other forms of non-transitory computer-readable media include disks, tapes, magnetic media, SSD, CD-ROMs, optical media, RAM, PROM, EPROM, and EEPROM, flash memory. Any other non-transitory computer-readable medium may be employed. Executing code may also be read from network link 218 (e.g., following storage in an interface buffer, local memory, or other circuitry).

It should be understood that the foregoing has presented certain embodiments of the invention but they should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, and not to imply endorsement or affiliation in any way.

1. A method, comprising:
with a production system having a first trained machine learning (ML) model deployed therein:
receiving an input network message and applying the input network message against the first trained ML model to produce an output that influences how the production system handles the input network message;
exporting the output and at least a portion of the input network message to a non-production system;
with the non-production system:
applying the at least a portion of the input network message to an authoritative ruleset to produce a correct answer;
calculating differences between the correct answer and the output from the production system, where at least one performance indicator is derived at least in part from the calculated differences;
upon the at least one performance indicator deviating beyond a configured performance level, automatically triggering retraining of the trained ML model;
performing said retraining of the first trained ML model using an updated set of data that is derived at least in part from the input network message, which the non-production system labeled with the correct answer;
said retraining generating a second trained ML model; and,
responsive to said generation of the second trained ML model, a control system replacing the first trained ML model in the production system with the second trained ML model.

2. The method of claim 1, where the output is any of a classification and a score.

3. The method of claim 1, where the production system comprises a firewall, and the output influences whether the firewall allows or blocks the input network message.

4. The method of claim 1, where the authoritative ruleset comprises any of: heuristics, regular expressions, network intelligence data.

5. The method of claim 1, further comprising the non-production system labeling and storing, in a repository, a plurality of input network messages versioned network traffic from the production system for use in the retraining.

6. The method of claim 1, where the at least one performance indicator is derived at least in part from a plurality of calculated differences between a plurality of outputs of the first trained ML model and a plurality of correct answers from the authoritative ruleset.

7. A system comprising a plurality of computers each having circuitry forming at least one processor and memory storing program instructions for execution on the at least one processor, the plurality of computers collectively forming a plurality of sub-systems including:
a production sub-system having a first trained machine learning (ML) model deployed that operates:
receive an input network message and applying the input network message against the first trained ML model to produce an output that influences how the production sub-system handles the input network message;
exporting the output and at least a portion of the input network message to a non-production sub-system;
the non-production sub-system operative to:
apply the at least a portion of the input network message to an authoritative ruleset to produce a correct answer;
calculate differences between the correct answer and the output from the production sub-system, where at least one performance indicator is derived at least in part from the calculated differences;
upon the at least one performance indicator deviating beyond a configured performance level, automatically triggering retraining of the trained ML model;
perform said retraining of the first trained ML model using an updated set of data that is derived at least in part from the input network message, which the non-production sub-system labeled with the correct answer;
said retraining generating a second trained ML model; and,
a control sub-system operative to, responsive to said generation of the second trained ML model, replace the first trained ML model in the production sub-system with the second trained ML model.

8. The system of claim 7, where the output is any of a classification and a score.

9. The system of claim 7, where the production sub-system comprises a firewall, and the output influences whether the firewall allows or blocks the input network message.

10. The system of claim 7, where the authoritative ruleset comprises any of: heuristics, regular expressions, network intelligence data.

11. The system of claim 7, the non-production sub-system operative to label and store, in a repository, a plurality of input network messages versioned network traffic from the production sub-system for use in the retraining.

12. The system of claim 7, where the at least one performance indicator is derived at least in part from a plurality of calculated differences between a plurality of outputs of the first trained ML model and a plurality of correct answers from the authoritative ruleset.

13. A non-transitory computer readable medium holding instructions for execution on at least one hardware processor to cause at least one computer to perform steps in a computer program, the steps comprising:
with a production system having a first trained machine learning (ML) model deployed therein:
receiving an input network message and applying the input network message against the first trained ML model to produce an output that influences how the production system handles the input network message;
exporting the output and at least a portion of the input network message to a non-production system;
with the non-production system:
applying the at least a portion of the input network message to an authoritative ruleset to produce a correct answer;
calculating differences between the correct answer and the output from the production system, where at least one performance indicator is derived at least in part from the calculated differences;
upon the at least one performance indicator deviating beyond a configured performance level, automatically triggering retraining of the trained ML model;
performing said retraining of the first trained ML model using an updated set of data that is derived at least in part from the input network message, which the non-production system labeled with the correct answer;
said retraining generating a second trained ML model; and,
responsive to said generation of the second trained ML model, a control system replacing the first trained ML model in the production system with the second trained ML model.

14. The non-transitory computer readable medium of claim 13, where the output is any of a classification and a score.

15. The non-transitory computer readable medium of claim 13, where the production system comprises a firewall, and the output influences whether the firewall allows or blocks the input network message.

16. The non-transitory computer readable medium of claim 13, where the authoritative ruleset comprises any of: heuristics, regular expressions, network intelligence data.

17. The non-transitory computer readable medium of claim 13, further comprising the non-production system labeling and storing, in a repository, a plurality of input network messages versioned network traffic from the production system for use in the retraining.

18. The non-transitory computer readable medium of claim 13, where the at least one performance indicator is derived at least in part from a plurality of calculated differences between a plurality of outputs of the first trained ML model and a plurality of correct answers from the authoritative ruleset.
